(19) United States
(12) Patent Application Publication
(10) Pub. No.: US 2011/0109050 A1
(43) Pub. Date: May 12, 2011

(54) GASKET

(76) Inventor: Laurence Kovacs, Cradley Heath (GB)

(21) Appl. No.: 12/740,333

(22) PCT Filed: Oct. 30, 2008
(86) PCT No.: PCT/GB2008/003662

§ 371 Date: Dec. 10, 2010

(30) Foreign Application Priority Data
Oct. 30, 2007 (GB) 0721223.6

(51) Int. Cl. H02G 15/013; F16J 15/02

(52) U.S. Cl. 277/627; 277/628; 277/654

(57) ABSTRACT

A gasket for an electrical back box, the gasket comprising a pad incorporating a composite of inert fibres along with an intumescent material portion, the pad encapsulated with an insulating layer with a lateral portion to provide a location bias, the pad having a density to provide a desired level of acoustic attenuation and/or damping when encapsulated in the insulating layer.

The present invention relates to gaskets and more particularly to a gasket utilised in an electrical back box such as at socket points, at light fittings or at distribution or junction boxes.

It is known to provide electrical cabling and wiring which extends to a back box to present a socket front plate or lighting switch or to allow electricity distribution within domestic or commercial premises. These back boxes are generally recessed within an aperture in a wall or may be surface mounted. In either event the electrical cable trunking or apertures in a cavity wall are potentially weak points in providing fire protection and/or audio conduits for sound.

It will be understood to retard fire providing a sealed environment will deny the fire access to oxygen and so will suppress, or at least impede, spread of fire in a building. Similarly, blocking open pathways with an acoustically damping material will reduce noise transfer about a building.

Unfortunately, even though partially blocked by the back box, there are apertures and conduits which are still relatively open and may allow oxygen ingress or sound transmission. It is known to use intumescent materials which rapidly expand to block vents upon exposure to high temperatures. These materials are used in respect of ventilation vents in buildings and some light fittings.

A problem within electrical and other open apertures is space. Typically, the back box will include terminals for electrical cabling as well as electrical switches and other elements such as plug receivers. Space is limited both within the box itself and the boxes are kept small so that the necessary size of an aperture to receive a box is limited. Accommodation of gaskets for acoustic attenuation as well as to present intumescent material, particularly in a correct and consistent orientation would be difficult. Thus, such arrangements do not commonly occur despite the clear benefits.

In accordance with aspects of the present invention there is provided a gasket for an electrical back box, the gasket comprising a pad incorporating a composite of inert fibres along with an intumescent material portion, the pad encapsulated with an insulating layer with a lateral portion to provide a location bias, the pad having a density to provide a desired level of acoustic attenuation and/or damping when encapsulated in the insulating layer.

Possibly, the central portion is deflectable to provide the location bias. Possibly, the lateral portion provides a stiffer edge to provide the location bias.

Typically, the inert fibre includes exfoliated graphite.

Possibly, the intumescent material portion is in the form of a powder or grains or fibres or discrete formed elements or a combination of these.

Possibly, the insulating layer is formed from polyvinylchloride (PVC). Advantageously, the lateral portion comprises overlaying sheet parts secured together by an adhesive bond. Possibly, the lateral portion is embossed with ribs for rigidity. Possibly, one side of the lateral portion carries a location adhesive. Advantageously, the location adhesive is covered by a masking strip until the location adhesive is required.

Typically, the gasket has apertures for cables and/or electrical connectors.

Generally, the gasket will incorporate more than one lateral portion for location bias. Normally, the lateral portions are opposed on each side of the gasket to facilitate location.

Also in accordance with aspects of the present invention there is provided an electrical back box arrangement comprising an electrical back box and a gasket as described above.

Typically, the arrangement is an electrical wall socket box or light switch box or junction box.

Normally, the gasket is arranged to lie against a rear or back surface of the back box and retained in position by the location bias. Generally, the lateral portions define a hinge with the remainder of the gasket. Typically, the hinge is located within the gaskets to present the lateral portion at an internal corner of the back box.

Aspects of the present invention will now described by way of example with reference to the accompanying drawings in which:—

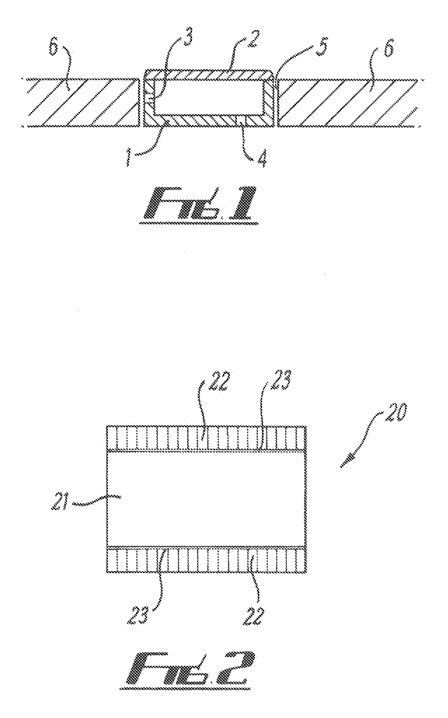

FIG. 1 is a schematic cross-section of an electrical back box located within a wall:

FIG. 2 is a schematic plan view of a gasket in accordance with aspects of the present invention;

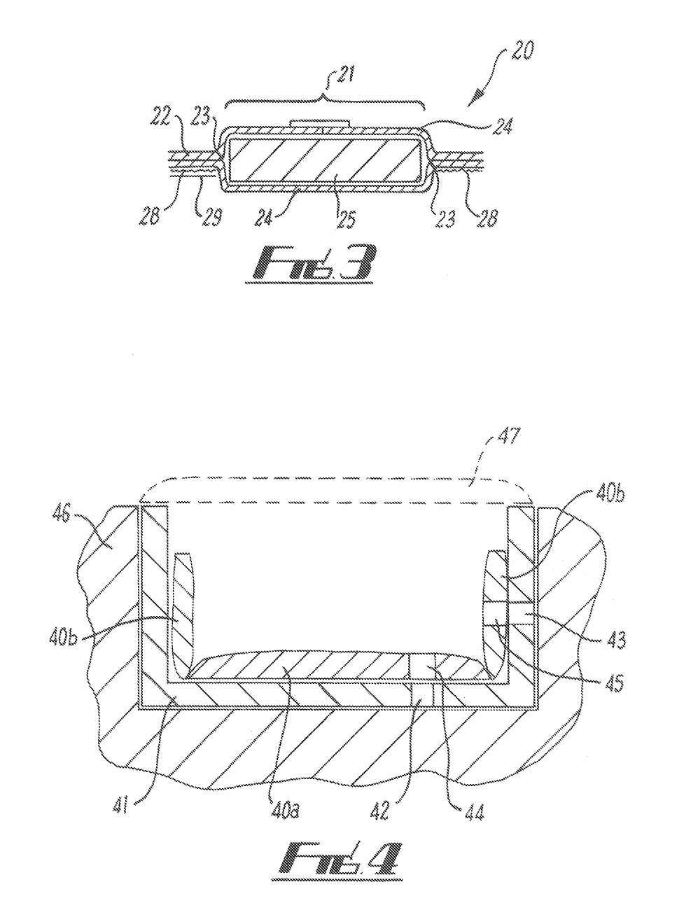

FIG. 3 is a schematic side cross-section of a gasket in accordance with aspects of the present invention; and,

FIG. 4 is a schematic side cross-section of a gasket in accordance with aspects of the present invention located within an electrical back box.

As indicated above, electrical back boxes are a convenient way of providing an enclosed space within or on a wall or other structure for the necessary connections and switches used in electrical wiring and cabling networks. Such back boxes prevent ingress of dust and provide a platform for the connectors and switches. However, air may still flow in and out of the box so in terms of fire protection oxygen may still be drawn in to feed a fire and audio noise may be transmitted through the box via cable trunking and channels.

Aspects of the present invention relate to a gasket to limit audio noise transmission across an electrical back box and to providing a deployable process for inhibition of fire propagation.

FIG. 1 provides a schematic side cross-sectional view of an electrical back box 1 located within a wall. Although an electrical back box 1 is illustrated and described in the example embodiment outlined below it will be appreciated that other back boxes may also be associated with a gasket in accordance with aspects of the present invention such water conduit junction boxes and optical fibre connector boxes. The back box 1 has a cover 2 which may carry a socket arrangement for an electrical plug or a switch mechanism. In either event the cover has apertures which allow air and noise ingress and egress. The back box 1 has access apertures 3, 4 which allow access by cables (not shown) either from the rear or side of the box 1. In such circumstances, the apertures 3, 4 are associated with conduits, trunking or the like for the cables or wires. Thus, there is a relatively open path through the back box 1.

The back box 1 is secured within an aperture 5 in a wall 6. The wall 6 normally forms part of a building or other structure. The electrical cable may be a source of an electrical fire itself through shorting but in any event the barrier to fire propagation provided by the wall 1 is compromised by the back box 1 having open paths for air flow.

It is known to use intumescent materials which expand on heating to block vents and other openings. However, traditionally the intumescent material has been presented in discrete solid sheet form to ensure correct presentation. Such an approach with an electrical back box may mean it is necessary to integrally form the intumescent with the back box upon manufacture. This will be inconvenient and as the intumecent material will be solid will provide no significant acoustic sound attenuation. Furthermore, by such an approach the back box would require replacement and could not be easily adapted in situ.

In accordance with aspects of the present invention a gasket 20 is provided comprising a pad at least partially encapsulated with a cover material. Normally, the cover material will be electrically insulating and/or where required waterproof. A central portion 21 of the gasket 20 is generally sized and shaped to be consistent will a back box within which the gasket 20 will be located in use. Thus, typically as depicted in FIG. 2 the gasket 20 will be rectangular but it will be appreciated that other shapes such as round or triangular may also be used.

The gasket 20 has lateral portions 22 which in a relaxed state extend laterally in the plane of the pad held within the gasket. As depicted the lateral portions 22 are normally in opposed pairs to provide location bias as will be described later. However, a single lateral portion 22 may be provide which does not have an oppose portion if the opposed edge can be held in position by the location bias provided by the single lateral portion. For example, the opposed edge may be held in a channel or surface features of a back box.

The lateral portions 22 generally form a hinge 23 with the central portion 21 such that as the portions are deflected from the relaxed lateral plane a tension develops in the cover to return at least the portions 22 to their relaxed state. This tension is resisted by engagement with the back box walls to develop the location bias. It will be appreciated that the strength of the location bias can be varied by the configuration of the cover in terms of the material from which it is formed, the thickness of the pad and the tautness of the portions when made.

In order to improve the effectiveness of the location bias the lateral portions 22 may be ribbed to provide reinforcement. Such ribbing may be provided by embossing ridges into the portions in an appropriate manner or heat treating the cover material forming the portions. Stiffeners may also be included in the gasket either in the lateral portion only or extending across the hinges 23. Stiffeners may be strands of wire or plastics material which when bent add to the location bias by shape bias, either to return to the relaxed state or to retain the deformed shape within a back box.

FIG. 3 provides a side cross-section of the gasket 20 as depicted in FIG. 2. As can be seen the gasket 20 comprises a cover 24 and a pad 25. The cover 24 is formed by overlapping sheets of material. The sheets can be single sheets laid one on top of the other or folded over to encapsulate the pad 25. Edge parts of the sheets are bonded together to form the lateral portions 22. The bonds may be an adhesive or though heat welding. The process of forming the lateral portions 22 may slightly compress the pad 25 to create some tension about the hinges 23 utilised to provide the location bias.

The cover 24 may completely surround the pad 25 or only partially encapsulate the pad 25 dependent upon requirements. Furthermore, the sheets forming the cover 24 may be arranged to have a seam 26 which is held together by an appropriate fixing such as a patch 27 or stitching. Thus, by ensuring the correct orientation is provided in the back box and configuration of the seam 27, a fixing for the seam can be arranged to act as a preference rupture site for better control of expansion of the intumensent component of the pad 25.

The material from which the cover 24 is made is chosen to provide required function. In an electrical back box generally the cover will be electrically insulating. Typically, the material may be polyvinylchloride (PVC) in sheet form and cut to the appropriate size.

The pad 25 is generally formed from a composite of fibres with possibly some powder or granular elements added. The fibres are inert and act as a matrix to present the intumesecent material, which may be in powder or granular form as well as provide an acoustic damping or attenuation response. The pad 25 will normally incorporate exfoliated graphite and other inert fibres. The composite will be formed as a relatively flat sheet of a felt like nature and having a thickness to achieve a desired function in the confined space within a back box.

It will be understood that the density of the pad will be sufficient to dampen or at least restrict passage of sound. Typically, there will be an objective to maintain the original acoustic rating of the structure e.g. wall before the aperture 5 (FIG. 2) is made to accommodate the back box 1. Thus, the pad 25 in accordance with aspects of the present invention provides both an acoustic attenuation function and a fire suppression function through an intumescent material component loading to the composite forming the pad 25 held within the cover.

It will be appreciated that the lateral portions 22 can be of any reasonable width and are specified to engage internal side walls of a back box in use. However, the wider the lateral portion then generally the greater spread of the location bias generated about the hinge 23. In order to further secure location at least one side of the portions 22 can carry an adhesive 28 to adhere the gasket to a side wall in a back box. Before entry the adhesive 28 may be covered with a strip of non-adhesive material such as greased paper 29. The strip 29 is then removed to expose the adhesive 28 prior to location of the gasket 20 within a back box.

The cover 24 may be formed from a material have an adhesive on one side. Thus, the pad is enveloped by the cover to create the lateral portions 22 and trimmed appropriately to size. Furthermore, the adhesive on the inner side will engage the pad 25 to retain the position of the pad 25 within the gasket 20.

The cover 24 and the pad will not be too solid in order to allow puncturing with apertures to allow cable or wire to pass through. It will be understood that the punctured holes or apertures will be small so that at least the pad will embrace the cables or wire to inhibit acoustic sound transmission through the gasket 20.

FIG. 4 provides a schematic illustration of a gasket 40 in accordance with aspects of the present invention located within a back box 41 which in turn is then located within a wall 46. The gasket 40 has a central portion 40a engaging against a rear inner surface of the back box 41 with lateral portions 40b extending upward against inner side walls of the box 41. In such circumstances, the lateral portions as discussed above generate a location bias in the direction of arrowheads A to retain the gasket 40 in terms of position within the box 41. It will be understood particularly to be effective with regard to acoustic attenuation that retention of gasket 40 position is important otherwise the acoustic pathways may not be plugged.

As indicated above the width of the lateral portions may be chosen dependent upon the requirements for location and to provide particularly acoustic sound attenuation and dampening against the side walls. As the lateral portions are held in bias whilst within the box 41 it will be understood these portions 40b will also be substantially flat to the side walls of the box 41.

Cables or wires can enter the back box 41 through apertures 42, 43 in the box 41. To enable the cables or wires to pass through the gasket 40 holes 44, 45 can be pre-cut or the gasket punctured.

In terms of action when acting for fire suppression it will be understood that intumescent materials have a rapid and large expansion upon attaining their activation temperature. Thus, the pad 25 (FIG. 3) will rapidly expand bursting the cover 24 and filing all available space in the box 41. All apertures 42, 43 and those in a face plate 47 will be closed. It is also possible that the plate 47 may be burst off from the box 41. In any event, the aperture in the wall within which the box 41 is located will be substantially closed preventing spread of fire or hot gases.

The gasket in accordance with aspects of the present invention combines provision of acoustic attenuation and means for fire containment through an appropriate pad 25 composite contained by a cover 24 to avoid loss of intumenscent material and/or to prevent electrical conduction by the gasket within a back box. Furthermore, through creation of lateral portions of appropriate size configuration and location of the gasket 20, 40 can be assured.

As indicated above, the lateral portions are generally flaps or wings which deflect in engagement with a back box to provide location. However, as an alternative the lateral parts may be short and simply provide a stiffer edge to facilitate location within the back box by inward construction of the overturned or otherwise formed lateral edge portions.

Alterations and modifications will be appreciated by those skilled in the technology. Thus, it will be understood that layers of material may be stacked to form the pad at the centre of the gasket and the gasket can be shaped for a particular back box size or configuration. Furthermore, the gasket may include a thermosetting component to allow curved or other shapes to be retained.

1. A gasket for an electrical back box, the gasket comprising a pad incorporating a composite of inert fibres along with an intumescent material portion, the pad encapsulated with an insulating layer with a lateral portion to provide a location bias, the pad having a density to provide a desired level of acoustic attenuation and/or damping when encapsulated in the insulating layer.

2. A gasket as claimed in claim 1 wherein the central portion is deflectable to provide the location bias.

3. A gasket as claimed in claim 1 wherein the lateral portion provides a stiffer edge to provide the location bias.

4. A gasket as claimed in claim 1 wherein the inert fibre includes exfoliated graphite.

5. A gasket as claimed in claim 1 wherein the intumescent material portion is in the form of a powder or grains or fibres or discrete formed elements or a combination of these.

6. A gasket as claimed in claim 1 wherein the insulating layer is formed from polyvinylchloride (PVC).

7. A gasket as claimed in claim 1 wherein the lateral portion comprises overlaying sheet parts secured together by an adhesive bond.

8. A gasket as claimed in claim 1 wherein the lateral portion is embossed with ribs for rigidity.

9. A gasket as claimed in claim 1 wherein one side of the lateral portion carries a location adhesive.

10. A gasket as claimed in claim 9 wherein the location adhesive is covered by a masking strip until the location adhesive is required.

11. A gasket as claimed in claim 1 wherein the gasket has apertures for cables and/or electrical connectors.

12. A gasket as claimed in claim 1 wherein the gasket will incorporate more than one lateral portion for location bias.

13. A gasket as claimed in claim 1 wherein the lateral portions are opposed on each side of the gasket to facilitate location.

14. (canceled)

15. An electrical back box arrangement comprising an electrical back box and a gasket as claimed in claim 1.

16. An arrangement as claimed in claim 15 wherein the arrangement is an electrical wall socket box or light switch box or junction box.

17. An arrangement as claimed in claim 15 wherein the gasket is arranged to lie against a rear or back surface of the back box and retained in position by the location bias.

18. A gasket as claimed in claim 15 wherein the lateral portions define a hinge with the remainder of the gasket.

19. A gasket as claimed in claim 17 wherein the hinge is located within the gaskets to present the lateral portion at an internal corner of the back box.

20. (canceled)
